(19) United States
(12) Patent Application Publication
(10) Pub. No.: US 2022/0287489 A1
(43) Pub. Date: Sep. 15, 2022

(54) DRINKING TUBE FOR AERATING A BEVERAGE

(71) Applicant: VARTAN ARUTYUNOVICH HAYRAPETYAN, Moscow (RU)

(72) Inventor: VARTAN ARUTYUNOVICH HAYRAPETYAN, Moscow (RU)

(73) Assignee: Yury Lavitas, Staten Island, NY (US)

(21) Appl. No.: 17/439,628

(22) PCT Filed: Feb. 12, 2019
(86) PCT No.: PCT/RU2019/000084

§ 371 Date: Sep. 15, 2021

(30) Foreign Application Priority Data
Sep. 18, 2018 (RU) 2018133089

(51) Int. Cl. A47G 21/18; B01F 23/236

(52) U.S. Cl. CPC A47G 21/18; B01F 23/236; B01F 2101/14

(57) ABSTRACT

A tube for drinking liquids has two opposite ends, an inner wall, an outer wall, a central part provided with a bend formed as a sylphone and having a throughgoing opening extending between the outer wall and the inner wall of the tube, one of the opposite ends of the tube being closed, and a throughgoing opening being provided in one of the walls of the tube near the dosed opposite end of the tube.

### FIELD OF TECHNOLOGY

The present utility model relates to devices which are used during drinking of beverages, such as straws or tubes for drinking, and it allows to produce an aerated beverage during its consumption.

### LEVEL OF TECHNOLGY

The first paper tube for drinking cocktails was invented by Marvin Stone in 1888 as disclosed in US patent No 375962. Its main disadvantages were associated with a material of which it was made.

Subsequently tubes from technologically better materials were produced and provided with sylphones which increase flexibility and universality of a tube, but without a possibility of aeration during consumption of a beverage.

The closest to the proposed technical solution is a tube or a straw which is disclosed in US Patent Application No. 2018028007 and is composed a tube provided in its wall with a throughgoing opening for aeration and a regulator of an air flow arranged in a groove on an outer wall of the tube. The tube of this construction provides aeration due to suction of air through the opening during sucking in a product through an upper end of the tube.

This tube however has several disadvantages: The aeration device is formed of one piece with the tube and cannot be used with standard single-use tubes for beverages.

The construction is complicated, and this complicates the manufacture of the aerating device and also its washing for further uses,

Moreover because of peculiarities of its construction it is expensive to manufacture.

### DISCLOSURE OF THE UTILITY MODEL

The technical problem which is to be resolved by the claimed utility model is an increase in aeration of a beverage.

The technical result of the claimed device resides in an increase of the effect of aeration due to entraining of a liquid in an air flow because taking in of a liquid in the proposed device takes place through an opening in a central part.

The technical result is achieved in that a drinking tube is proposed for aeration of a beverage, containing a tube with an opening for aeration and a regulator of an air flow, and is a central part there is a bend by means of a sylphone, in this portion at least one opening is provided in a tube wall with a diameter from 3 to 7 mm, an aeration opening is located from an opposite tube end for drinking at a distance from 5 to 30 mm, the regulator of an air flow is formed formed as a cap and has a throughgoing opening in a wall with a diameter of 3 to 7 mm, the regulator is placed with a tension on a butt end of the tube end where the opening for aeration is located with a possibility of movement so that the opening for aeration of the tube and the throughgoing opening of the regulator can coincide.

In a preferable option:
the regulator of the air flow is arranged to surround the tube;
the regulator of the air flow is arranged in a cavity of a tube casing;
the regulator of the air flow is formed with a possibility of rotation around an axis of a tube casing over a thread;
a part of the regulator of the air flow with an opening is formed with a smaller diameter than a remaining part.

The combination of the above-described essential features leads to the advantage that the device is a reliable inexpensive in manufacture tube, allowing to consume beverages both with aeration and without it.

### BRIEF DESCRIPTION OF THE DRAWINGS

The essence of the claimed utility model is clarified by the figures.

FIG. 1 shows a general view of a tube with aeration of liquids, in which
the numerals identify:
a body of the tube;
a regulator of an air stream;
6—an aeration opening in the body of the tube.

FIG. 2 shows a construction of the tube for aeration in a cross-section of
FIG. 1, where numeral identify:

1 the body of the tube;
2 a bend of the tube (sylphone);
3 the regulator of the air stream;
4 an opening for a liquid in the tube;
5 a free end of the tube, for consuming beverages;
6 the opening in the body of the tube;
7 an opening in a valve.

### REALIZATION OF THE UTILITY MODEL

Below an example is given of a specific implementation of an aeration device, which does not limit variants of its construction.

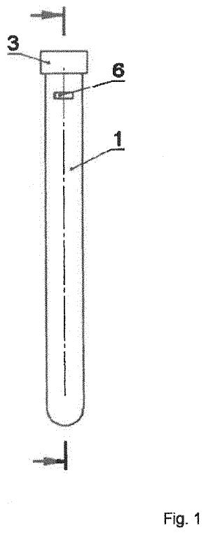

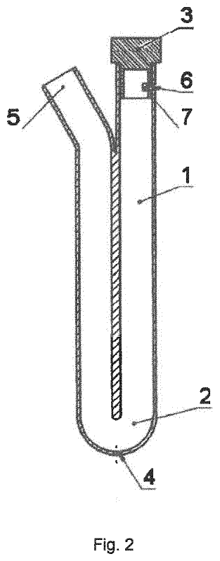

The proposed technical solution according to FIGS. 1 and 2 is composed of a hollow cylinder of a tube (body) I formed so that it can be bent by means of a sylphone. In a central part or near it of the tube body 1 there is a bend by means of a sylphone 2, and in this area there is at least one opening 4 with a diameter of from 3 to 7 mm, which connects inner and outer walls of the body 1. A throughgoing opening 6 is provided in a wall of the tube body 1 at a distance from 5 to 30 mm from the end of the tube body 1, with a diameter from 3 to 7 mm, and at the same end a regulator 3 of an air stream provided having a smaller diameter then the tube for installing in it, or a greater diameter for arranging around the tube. The regulator of air stream 3 provided for a fixation inside the body 1 of the tube for convenience can have different diameters, including a smaller diameter for installing inside the body 1 of the tube, a greater diameter for ability to rotate, with a difference in diameters serving as an abutment, The free end of the tube serves for consuming of a beverage, The regulator can contain a minimum of one throughgoing opening 7 in the wall with a diameter from 3 to 7 mm, and it is installed on the end of the body 1 of the tube with a possibility of rotation and movement.

The air stream regulator 3 is fixed on the body 1 of the tube:
either by means of a thread connection (not shown in the drawings), which is preferably is limited by a thread so that the regulator will move but will not be screwed off from the body of the tube:
or by means of guides (not shown in the drawings) limited by blocks so that the regulator can have a movement along an axis of the tube and/or around it;
or the air flow regulator is placed on the body of the tube, and its movement is limited by projections-limiters on the surface of the tube or inside it.

The opposite face of the setting end of the regulator can be provided with a attachment of a greater diameter than the regulator itself for a more comfortable rotation.

The device is composed of plastic, wood, metal and another material, suitable according to it physical-mechanical properties and allowable for use in a food industry.

The claimed device is easy to manufacture because its construction is simplified: there is no inner ribs and cavities, and there is no reverse valve.

The tube can be for a multi-use (as a souvenir), it can have different shapes (extendable, with a bendable upper part, for more comfortable use, etc.), of any color, size and diameter.

The device operates in the folio wing manner:

The claimed device is used for aeration of beverages and it replaces a single-use tube for beverages. The claimed device allows to aerate any beverages during suction of them through the tube. During suction of a beverage through the tube with the device for aeration an air supply into a consumed beverage takes place through the openings 6 and 7. The air is mixed with the consumed beverage supplied through the opening 4, and the aerated beverage is received in a user's mouth. The supply of air takes place during the whole time of the process of suction of the beverage through the device. The device has the regulator of the air stream 3, which is used for regulation of a quantity of the supplying air, for obtaining a desired ratio of air in the beverage during its consumption by a user, with a possibility to exclude completely the air supply in a certain position.

During consumption of a beverage the tube is introduced in a liquid so that a lower part of the bend 2 and the lower opening 4 will be sinking in the beverage, then during sucking in of the beverage the user, by turning and moving the regulator 3, regulates the air supply into the beverage, correspondingly, when the openings of the regulator 7 and of the tube 6 do not coincide, air during drinking is not supplied, when they coincide it is supplied not completely but weaker, and during the full coincidence of the openings of the tube 6 and the regulator 7 the aeration of the beverage is minimal.

In this way the claimed device solves the main problem, in particular it allows to use the simple to manufacture device for aeration of beverages during drinking, and not as in known solutions not the air is introduced into the beverage, but the beverage is introduced into an air stream, which results in a more aerated consistency of the beverage. During the consumption of a liquid through the claimed device user feels a calming effect and an effect of cooling the beverage.

This makes possible to use the device in networks of a public food consumption and to execute with its help the aeration of any beverages.

1-5. (canceled)

6. A tube for drinking liquids, comprising two opposite ends; an inner wail; an outer wall; a central part provided with a bend formed a sylphone and having a throughgoing opening extending between the outer wall and the inner wail of the tube, wherein one of the opposite ends of the tube is closed; and a throughgoing opening provided in one of the walls of the tube near the closed opposite end of the tube.

7. The tube for drinking liquids of claim 6, and further comprising a regulator associated with the opposite end of the tube and interacting with the throughgoing opening of the one opposite end of the tube to regulate a flow of aft through the throughgoing opening into the tube.

8. The tube for drinking liquids of claim 7, wherein the regulator associated with the opposite end of the tube and interacting with the throughgoing opening of the one opposite end of the tube is located outside the tube and surrounds it from the outside.

9. The tube for drinking liquids of claim 7, wherein the regulator associated with the opposite end of the tube and interacting with the throughgoing opening of the one opposite end of the tube is located inside the tube.

10. The tube for drinking liquids of claim 7, wherein the regulator associated with the opposite end of the tube and interacting with the throughgoing opening of the one opposite end of the tube to regulate a flow of air through the throughgoing opening into the tube has an opening with a smaller diameter than a diameter of the throughgoing opening of the one opposite end of the tube.
